(19) United States
(12) Patent Application Publication
(10) Pub. No.: US 2025/0282555 A1
(43) Pub. Date: Sep. 11, 2025

(54) CONVEYOR DEVICE AND FILLING MACHINE FOR PASTY FOODS

(71) Applicant: VEMAG Maschinenbau GmbH, Verden (DE)

(72) Inventors: Kersten Nilsson, Verden (DE); Tobias Kiel, Verden (DE); Sven Köhler, Verden (DE)

(21) Appl. No.: 19/072,372

(22) Filed: Mar. 6, 2025

(30) Foreign Application Priority Data
Mar. 8, 2024 (DE) 102024106772.1

(51) Int. Cl. B65G 33/18; A22C 11/08; A22C 17/00; B65G 33/22

(52) U.S. Cl. CPC B65G 33/18; A22C 11/08; A22C 17/0026; B65G 33/22

(57) ABSTRACT

A conveying device is provided for a pasty food product such as meat or pasta products. The conveying device includes a housing having a food inlet and a food outlet and a conveying chamber, a first conveying screw rotatably arranged in the conveying chamber and a second conveying screw rotatably arranged in the conveying chamber. The first and the second conveying screws are arranged with their axes of rotation substantially parallel with each other and have intermeshing helical coils. The pitch of the coils of the conveying screws becomes continuously smaller in at least one section between the inlet and the outlet, thereby to precisely portion the food product while avoiding smearing or gas bubble formations.

### CROSS-REFERENCE TO RELATED APPLICATION

This application claims priority to German Patent Application No. 102024106772.1, filed Mar. 8, 2024. The above-mentioned patent application is incorporated herein by reference in its entirety.

### TECHNICAL FIELD

This application relates to a conveying device including a housing having a food inlet and a food outlet and a conveying chamber, a first conveying screw rotatably arranged in the conveying chamber and a second conveying screw rotatably arranged in the conveying chamber, with the first and the second conveying screws being arranged with their axes of rotation substantially parallel with each other and have intermeshing helical coils.

### BACKGROUND

Conveying devices of the above kind, which are known from the prior art, for example from the European Patent No. EP 2769621 B1 or European Patent No. EP 2710896 B1, each owned by the applicant, are used to produce and process pasty foods such as meat emulsion or dough. In the following, the expression ‘product’ or ‘mass’ is also used synonymously for ‘food’. The conveying devices are used in a vacuum stuffing machine, for example. Inside the housing, an inlet and an outlet are provided, as well as two conveying screws, also referred to as twin screws or double screws, which are arranged with their helical coils rotatably movable inside the conveying chamber formed in the housing and which can be driven by a motor, the product being moved by the intermeshing coils in a substantially longitudinal direction of the conveying screws and thus in a conveying direction inside cavities of the conveying chamber.

The food industry requires high standards of product quality. Processing plants and producers of food conveying devices are intensifying their efforts to provide products with a high quality standard, good appearance and in precise amounts. When conveying and processing pasty foods, the quality and appearance of the product are affected by the presence of gases in the form of gas bubbles. Degassing, meaning the elimination of large gas bubbles from the food, is of substantial importance. In conveying devices of the kind initially specified, it is also important to counteract smearing, which in the case of meat products is understood to mean disadvantageous effects caused by particles of food rubbing against the walls of the conveyor, such as the housing walls and the surfaces of the conveying screws in the present case. Smearing causes an emulsion to form in the food as a result of shearing. This causes the meat cells to rupture and intracellular fluid to leak out; fat cells lose part of their fat. As a result, the sausage material acquires a greasy consistency with a greater risk of food decay (e.g. susceptibility to oxidation). Its suitability for processing is also impaired.

Given this background, one object of the present invention is to specify a food conveying device that does not adversely affect the quality of the food, or only to a minimal extent, and that ensures a high standard of food quality, that prevents smearing, in particular, and that also reduces any unfavorable effects of gas bubbles; highly precise portioning of the food to be conveyed is also to be achieved.

### SUMMARY

To achieve these and other technical objectives, the food conveying device of this application is of the kind initially specified, and in which the pitch of the coils of the conveying screws becomes continuously smaller in at least one section between the inlet and the outlet.

According to embodiments of the invention, the continuously decreasing pitch of the conveying screw coils in at least one section of the conveying screws and hence also in at least one section of the conveying chamber results in a continuous decrease in the free volume for food in the region of the twin screw set. At the same time, the volumes in the chamber are kept as tightly sealed as possible, with minimal defined gaps between the surfaces of the conveying screws and the inner surfaces of the housing. This results in low backflow of the food mass. Smearing effects are reduced. Portioning, i.e. the conveyed amount of food mass, is also more precise as a result. Due to the pitch in this section decreasing continuously in the conveying direction, the volume becomes smaller, thus resulting in compaction of the product.

The effects according to embodiments of the invention are also particularly pronounced when the conveying device is used in conjunction with a vacuum stuffing machine in which at least one section of the conveying screws is exposed to a negative pressure (vacuum) in order to suck the food mass into the chamber in the region of the conveying screws. However, the free volumes may nevertheless be filled to less than capacity, which is undesirable because some products may then contain gas inclusions. To offset this, and in particular to reduce the size of gas inclusions, the volume is made smaller and the food mass is compacted by the pitch of the coils becoming continuously smaller, in accordance with embodiments of the invention.

According to a preferred embodiment, it is proposed that each conveying screw has a plurality of sections in the axial direction along the axes of rotation, in particular a drive section, a vacuum section, a compaction section, a portioning section and/or an outfeed section. This kind of sectional design creates adjoining functional areas, each of which can work efficiently so that conveying is gentle to the products and results in precise portioning. According to embodiments of the invention, it is preferable that all the aforementioned sections are provided in the aforementioned order or also in a different order, where necessary. Alternatively, however, the conveying device could also be functional if only selected sections from the above list are present.

Another preferred embodiment of the invention is one in which the section with the continuously decreasing pitch of the conveying screw is designed as a compaction section in such a way that the free volume for the food to be conveyed decreases continuously in the conveying direction in that section.

It is purposeful, with a view to conveying the food mass gently and efficiently, that the compaction section is provided at least partly adjacent to the inlet in an infeed area of the housing. It is also preferred that the compaction section is designed with a pitch that becomes continuously smaller downstream from the infeed area, and preferred that the compaction section is arranged at least partly underneath the inlet and the infeed area. In the latter case, in particular, the force of gravity supports conveying, typically from a feed hopper of a stuffing machine, such that the compaction section is arranged directly below the infeed area and underneath the inlet for the food mass, which typically is arranged radially in relation to the longitudinal axes of the conveying screws.

In an alternative embodiment, the compaction section with the decreasing pitch of the coils protrudes partly into the vacuum section, with the advantageous effect that the product is sucked in efficiently and is then compacted instantly and conveyed through the decreasing volumes in the region of the conveying screws. It is preferable, alternatively, that the compaction section extends as far as the outlet region, thus allowing greater compaction.

Another preferred embodiment of the invention is one in which, viewed along the conveying direction, the conveying screws have a vacuum section, the compaction section adjoining the vacuum section, the portioning section adjoining the compaction section, and the outfeed section adjoining the portioning section in the conveying direction.

In another preferred embodiment, each vacuum section of the conveying screws has coils with a substantially constant pitch, and the portioning section has the change in pitch at least in sections, wherein the compaction section with a continuously decreasing pitch of the coils is arranged between the vacuum section and the portioning section.

A favorable geometrical design is also obtained if the length of the portioning section is approximately 1.5 to 4 times and preferably twice the pitch of the portioning section.

### BRIEF DESCRIPTION OF THE DRAWINGS

Embodiments of the invention shall now be described with reference to a conveying device and a stuffing machine shown in the attached Figures and described in the subsequent description.

FIG. 1 is a side view of a stuffing machine and a conveying device in a partial cross-sectional view.

FIG. 2 is a top view onto the housing and onto the first and second conveying screws inside the housing.

FIG. 3 is a top view onto the housing of the conveying device.

FIG. 4 is a cross-sectional view taken along the line A-A in FIG. 3.

FIG. 5 is a more detailed partial cross-sectional view through the housing in the region of the outfeed section of the conveying screws and the housing of the conveying device.

FIG. 6 is a side view of another embodiment of the conveying screw with some angular dimensions indicated.

FIG. 7 is a side view of another embodiment of the conveying screw with some pitch dimensions indicated.

### DETAILED DESCRIPTION

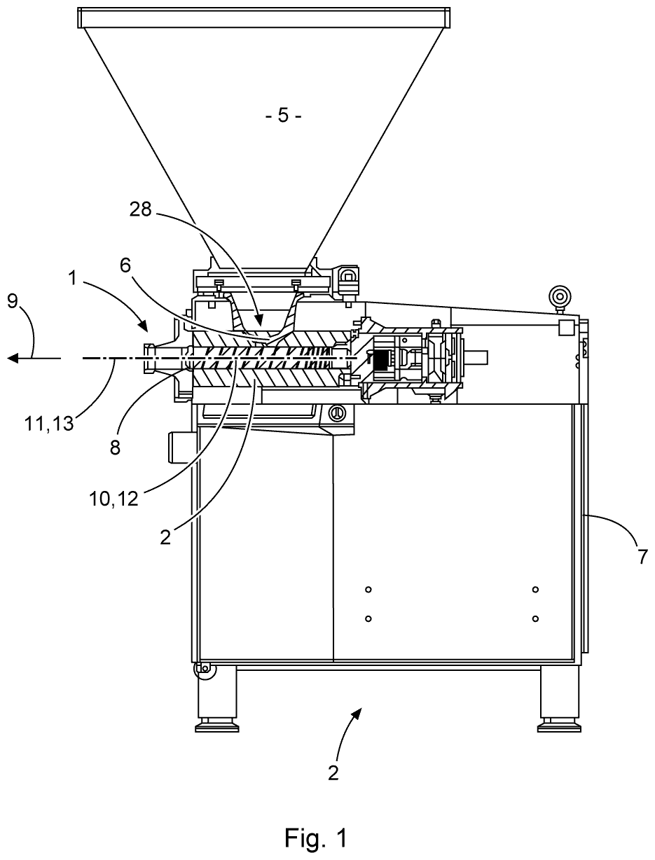

FIG. 1 shows a stuffing machine 3 according to one embodiment of the invention in a cross-sectional view from the side. A conveying device 1 for pasty food is integrated here in the housing of stuffing machine 3; alternatively, conveying device 1 may also be designed as a standalone machine in a separate housing. The conveying device 1 shown here is integrated in a stuffing machine 3 having a feed hopper 5 for receiving the food to be conveyed, wherein the feed hopper 5 of stuffing machine 3 is arranged substantially above conveying device 1 in such a way that the free-flowing food can be fed via an infeed area 28 into an inlet 6 formed in housing 2.

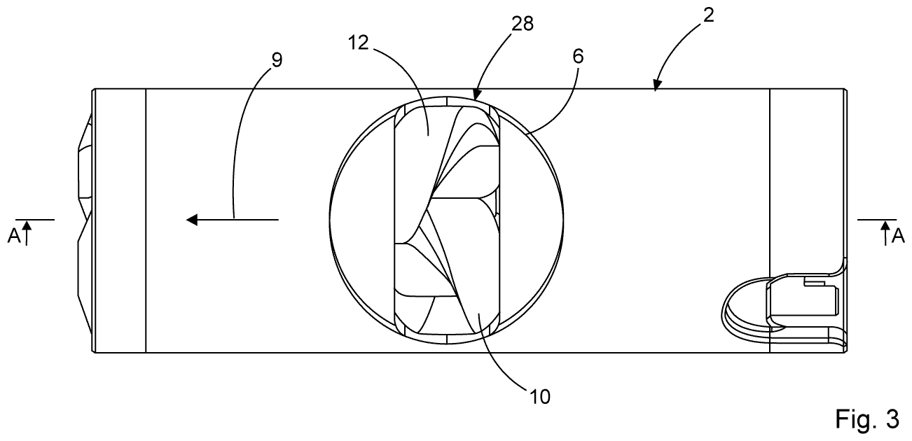

As FIGS. 1 through 4 further illustrate, conveying device 1 has a housing 2 made of metal, preferably of stainless steel. Housing 2 has a hollow space that defines a conveying chamber 4. A pasty free-flowing food mass can be fed radially from above through a food inlet 6 and through an infeed area 28 into conveying chamber 4. A food outlet 8 is also provided, via which the conveyed mass can be dispensed and further processed.

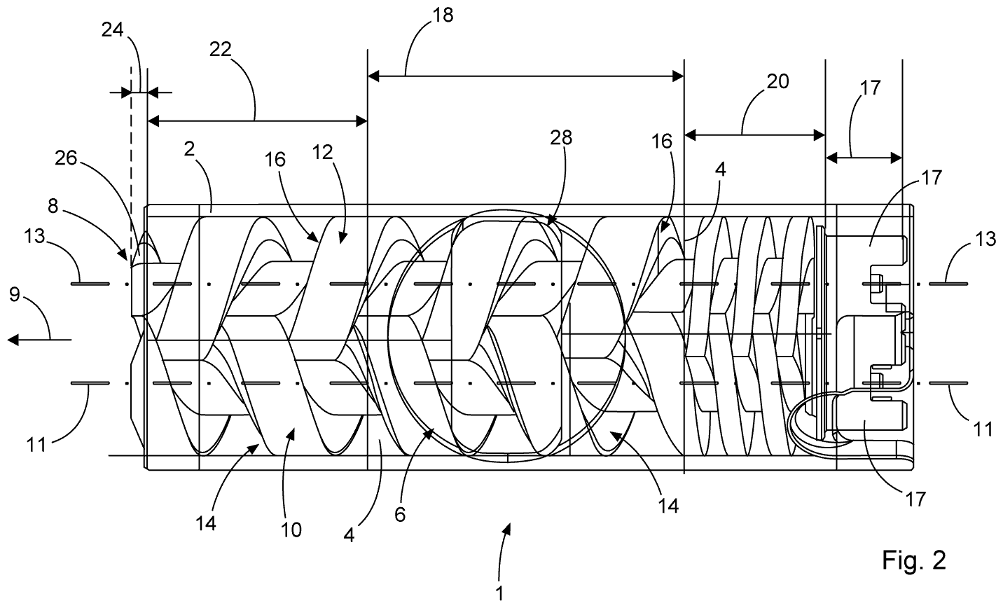

As illustrated by FIGS. 2 through 5, a first rotatably mounted conveying screw 10 which can be driven by drive motor is arranged inside conveying chamber 4, as is a second conveying screw 12 that is likewise rotatable. The first and second conveying screws 10, 12 have rotational axes 11, 13 arranged parallel with one another. The two conveying screws 10, 12 have outwardly projecting helical coils 14, 16 that intermesh with each other. At their outer periphery, coils 14,16 abut the inner surface of housing 2; the peripheral surfaces of coils 14,16 are substantially helical in shape and are designed with a planar periphery so that an elongated gap is produced at the periphery between the surface of coils 14, 16 and the surface of housing 2, thus providing a seal. A conveying chamber 4 is thus formed by conveying screws 10, 12 in conjunction with housing 2, and has a plurality of cavities into which the food mass enters and is conveyed substantially in conveying direction 9 from inlet 6 to outlet 8 when conveying screws 10, 12 are rotated about their respective rotational axes 11 and 13.

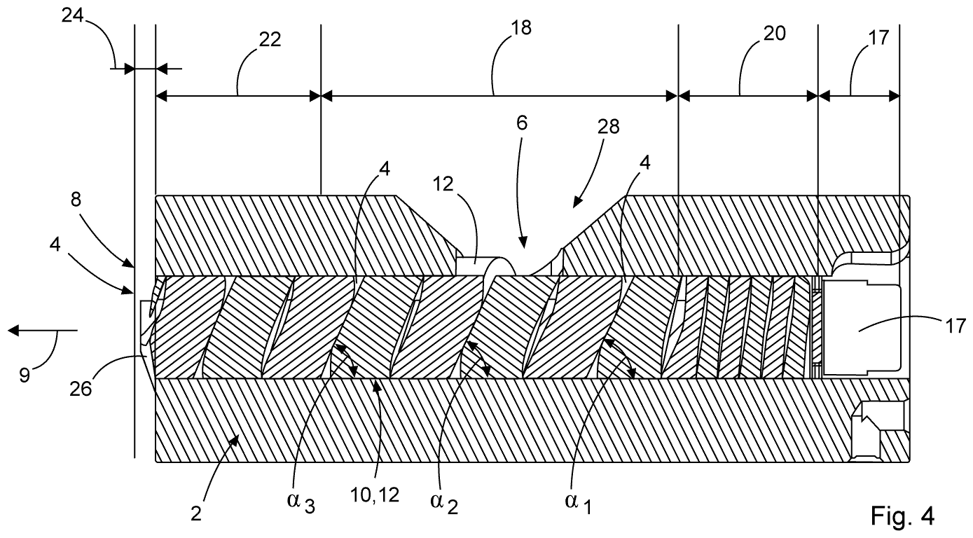

In the embodiment shown, and as can well be seen in FIGS. 2 and 4 by way of example, each conveying screw 10,12 has a plurality of sections 17, 18, 20, 22, 24, 26, in particular, when viewed in conveying direction 9, a drive section 17, a vacuum section 20, a compaction section 18, a portioning section 22 and/or an outfeed section 24. On the right in FIGS. 2 and 4, a drive section 17 can be seen on each of conveying screws 10, 12, which can be coupled in each case to a drive motor (not shown) in order to rotatably drive conveying screws 10, 12.

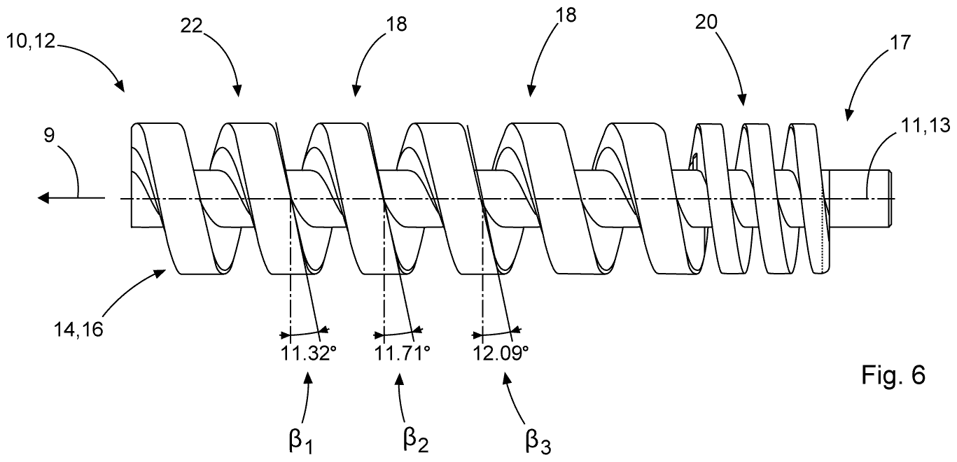

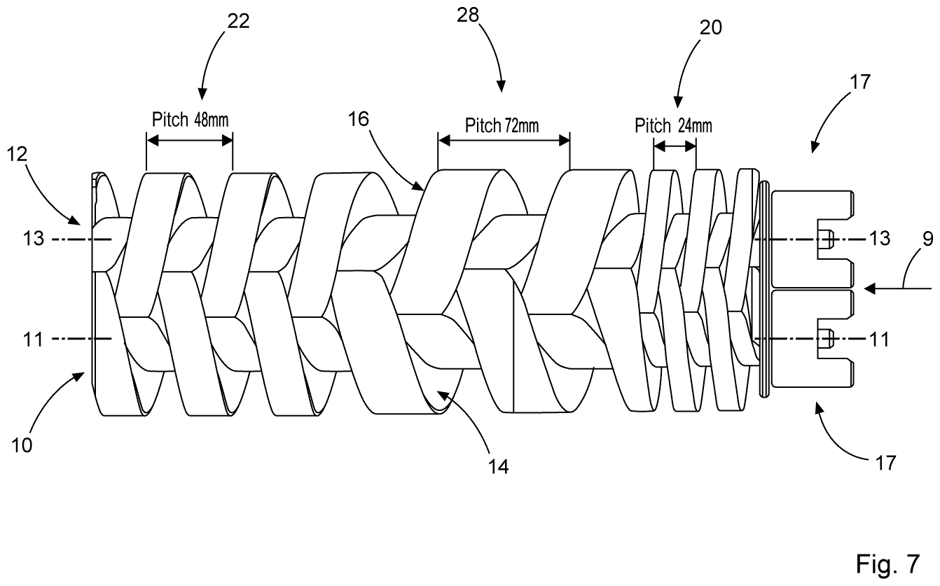

As illustrated in particular by FIGS. 2 and 4 and by FIGS. 6 and 7, the coils 14, 16 of conveying screws 10, 12 have a pitch (also illustrated by the angle α in FIG. 4 or by angle β in FIG. 6, or by the specified pitches in FIG. 7). The pitch may be different in different sections of conveying screws 10, 12. The pitch of coils 14, 16 of conveying screws 10, 12 is so designed that it becomes continuously smaller in at least one section 18 between inlet 6 and outlet 8; in the embodiment shown, this is the case in a compaction section 18, as can be seen in FIG. 4 and as illustrated by the different angles α marked at three places within compaction section 18. In FIG. 4, angles α are marked between the flanks of coils 14, 16 and a line parallel with rotational axis 11, 13. Angle α, which is a measure of the pitch of coils 14, 16 in this area, increases in conveying direction 9, for example from α1 equal to 83°, to α2 equal to 74° to α3 equal to 78°.

The pitches are also illustrated in attached FIGS. 6 and 7. In FIG. 6, three angles β1, 2, 3 are marked at three places by way of example, in this case between the flanks of coils 14, 16 and a line perpendicular to rotational axis 11, 13. β1 is 11.32°, β2 is 11.71° and β3 is 12.09°.

FIG. 7 illustrates by way of example the definition of a pitch, in this case at three different places with a pitch of 48 mm in the region of portioning section 22, a pitch of 72 mm in the region of infeed area 28 and a pitch of 24 mm in the region of vacuum section 20.

In the embodiment shown, section 18 with the continuously decreasing pitch of the conveying screw coils is designed as a compaction section 18 such that the free volume for the food to be conveyed decreases continuously in conveying direction 9 in that section, and the product is compacted when conveyed in conveying direction 9. Compaction section 18 is provided at least partly adjacent to inlet 6 in infeed area 28 of housing 2; more precisely, compaction section 18 is arranged partly underneath inlet 6 and infeed area 28. Compaction section 18 with the continuously decreasing pitch extends further downstream from infeed area 28 in conveying direction 9.

It can be seen well in FIGS. 2 and 4 that compaction section 18 with a decreasing pitch protrudes partly into vacuum section 20. On the opposite side, compaction section 18 extends in the direction of outlet 8, in the embodiment as far as a portioning section 22. The following order of sections is thus formed: conveying screws 10, 12 have a drive section 17, a vacuum section 20, a compaction section 18 adjoining vacuum section 20 in conveying direction 9, a portioning section 22 adjoining the compaction section 18 in conveying direction 9, and an outfeed section 24 adjoining portioning section 22 in conveying direction 9. The vacuum section 20 of conveying screws 10, 12 preferably has coils 14, 16 with a substantially constant pitch.

Alternatively, in a manner not shown, portioning section 22 instead of compaction section 18 may have the change in pitch, i.e. a continuously decreasing coil pitch. For example, the length of portioning section 22 is approximately 1.5 times the pitch of portioning section 22.

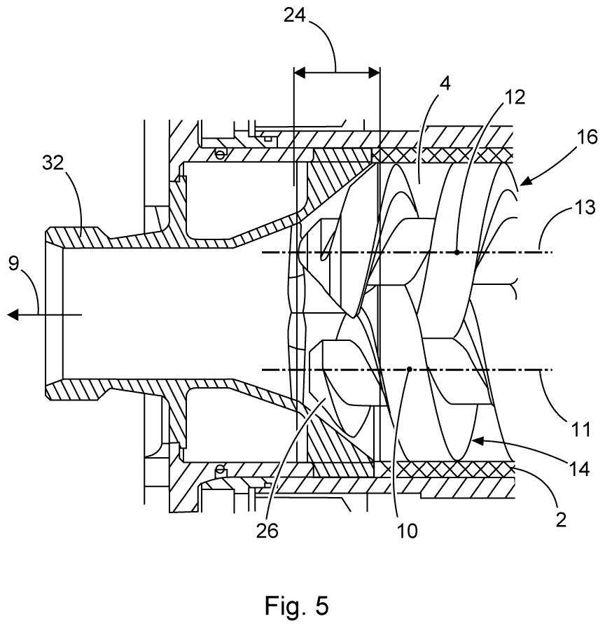

Conveying device 1 is so designed that at least one attachment, for example a stuffing tube or a length portioning device, not shown but known from the prior art, or a minced meat processing device or a sausage casing holder, adjoins the outlet axially downstream in the conveying direction. For that purpose, an adapter in the form of a stuffing tube holder 32, to which the attachment can be connected, is mounted on machine frame 7. In the embodiment shown, a stuffing tube holder 32 can be releasably coupled to machine frame 7, as illustrated in particular by the enlarged view in FIG. 5.

FIG. 5 shows an enlarged view of an outfeed section 24 comprising an inwardly tapering outfeed cone 26 that is part of the two conveying screws 10,12.

The pitches of coils 14, 16 are calculated using the following equation, for example:

Calculation of pitch in each section:
1. Linear pitch in the portioning section
2. Continuously changing pitch in the compaction section
3. Linear pitch under the infeed
4. Linear pitch in the vacuum section

### Section 1:0 . . . t₀

### Function:

$$f ( t ) = a * t$$

where:

$$\begin{matrix}a = \frac{pitch [ mm ]}{circumference [ mm ]} \\ t = number of turns [ - ] * circumference [ mm ]\end{matrix}$$

Example: pitch=96 mm, length of pitch=144 mm, diameter of screw=108 mm

$$\begin{matrix}\to a = \frac{96 mm}{108 mm * π} = 0.2829 \\ \to No . of turns = \frac{144 mm}{96 mm} = 1.5 \\ t = 0 … ( 1.5 * 108 * π ) = 0 … 508 , 938\end{matrix}$$

Section 2: t₀ . . . t₁

### Function:

$$f ( t ) = a * t + c * {( t - {t}_{0} )}^{2}$$

Factor c affects the total length of the screw and is chosen such that the length fits.

Section 3: t₁ . . . t₂

### Function:

$$f ( t ) = b * t - d$$

where:

$$\begin{matrix}b = a + 2 * c * ( {t}_{1} - {t}_{0} ) \\ d = c * ( {t}_{1}^{2} - {t}_{0}^{2} )\end{matrix}$$

Section 4: t₂ . . . t₃

$$f ( t ) = e * t + g$$

### Function:

where:

$$\begin{matrix}e = \frac{pitch [ mm ]}{circumference [ mm ]} \\ g = \frac{f ( {t}_{2} )}{e * {t}_{2}} \\ t = length of screw\end{matrix}$$

What is claimed is:

1. A conveying device for pasty food, comprising:
a housing having a food inlet and a food outlet and a conveying chamber,
a first conveying screw rotatably arranged in the conveying chamber, and
a second conveying screw rotatably arranged in the conveying chamber,
wherein the first and second conveying screws are arranged with respective axes of rotation substantially parallel with each other and the first and second conveying screws have intermeshing helical coils, and
a pitch of the coils of the conveying screws becomes continuously smaller in at least one section between the inlet and the outlet.

2. The conveying device of claim 1, wherein each of the first and second conveying screws has a plurality of sections in an axial direction along the axes of rotation, and the plurality of sections include at least one of a drive section, a vacuum section, a compaction section, a portioning section, and an outfeed section.

3. The conveying device of claim 2, wherein the compaction section is where the pitch of the coils of the conveying screw becomes continuously such that a free volume for the food to be conveyed decreases continuously in a conveying direction in that section.

4. The conveying device of claim 3, wherein the compaction section is provided at least partly adjacent to the inlet in an infeed area of the housing.

5. The conveying device of claim 4, wherein the compaction section is designed with a pitch that becomes continuously smaller downstream from the infeed area.

6. The conveying device of claim 4, wherein the compaction section is arranged at least partly underneath the inlet and the infeed area.

7. The conveying device of claim 3, wherein the compaction section protrudes partly into the vacuum section.

8. The conveying device of claim 7, wherein the compaction section extends as far as a region of the outlet.

9. The conveying device of claim 2, wherein the compaction section is adjacent to the vacuum section in a conveying direction, the portioning section is adjacent to the compaction section in the conveying direction, and the outfeed section is adjacent to the portioning section in the conveying direction.

10. The conveying device of claim 2, wherein each vacuum section of the first and second conveying screws has coils with a substantially constant pitch and each portioning section has a change in pitch at least in sections, wherein the compaction section including a continuously decreasing pitch of the coils is arranged between the vacuum section and the portioning section.

11. The conveying device of claim 2, wherein a length of the portioning section is approximately 1.5 to 4 times the pitch of the portioning section.

12. The conveying device of claim 1, wherein at least one attachment, defined by at least one of a stuffing tube, a length portioning device, a minced meat processing device, or a sausage casing holder, can be releasably coupled to the housing by an adapter adjacent to the outlet axially downstream in a conveying direction.

13. The conveying device of claim 1, wherein the conveying device is integrated in a stuffing machine having a feed hopper for receiving the food to be conveyed, wherein the feed hopper of the stuffing machine is arranged substantially above the conveying device in such a way that the food can be fed into the inlet via an infeed area.

14. A stuffing machine having the integrated conveying device of claim 2.
